(19) United States
(12) Patent Application Publication
(10) Pub. No.: US 2025/0341753 A1
(43) Pub. Date: Nov. 6, 2025

(54) GENERIC MODULE FOR PURE PHOTONS ENTANGLEMENT

(71) Applicant: OZ Optics Ltd., Ottawa (CA)

(72) Inventor: Mamoun Wahbeh, Stittsville (CA)

(21) Appl. No.: 19/199,223

(22) Filed: May 5, 2025

Related U.S. Application Data
(60) Provisional application No. 63/642,252, filed on May 3, 2024.

(51) Int. Cl. G02F 1/35; G02F 1/355

(52) U.S. Cl. CPC G02F 1/3519; G02F 1/3503; G02F 1/3551; G02F 1/3558; G02F 2203/07

(57) ABSTRACT

An interferometric module, constructed in single pentagonal block to produce high quality, robust, low cost entangled-photon sources enabling polarization entanglement swapping. The compact block forms a generic platform that facilitates a comprehensive integration of optical components while allowing for quick optical alignments. Phase-stability of the self-balanced Sagnac interferometer is harnessed to offer a highly stable performance at room temperature and under sever operating conditions. High-quality entanglement is inherently achieved by equalizing two interferometric optical paths from counter-propagating photons. A periodically poled nonlinear crystal is placed between two half-wave plates, which also serve to correct the polarization states of the photons. The result is compensation-free and plug-and-play entangled-photon sources for quantum routers, distributed quantum sensing and quantum telecommunication. Wavelengths and generation rate of photon pairs are realized via the hosted crystal. Energy and polarization entanglement, and hyperentanglement can be remotely set by rotating the polarization state of the pump laser diode.

### TECHNICAL FIELD

There is provided a generic module for pure photons entanglement, particularly including an interferometric Sagnac loop and periodically poled nonlinear crystals (PPNC) accommodated in a single, compact pentagonal housing block.

### BACKGROUND OF THE INVENTION

Shor's algorithm has brought up a growing attention to quantum computing since Peter Shor developed it in 1994 to find the prime factors of large numbers [1]. Although the idea to merge quantum mechanics and information processing was brought up back in the 1970s, Shor's insight has a vital impact on attracting such efforts that were previously sought in 1982 when physicist Richard Feynman suggested if the quantum effects such as superposition and entanglement could be harnessed and deployed in computation [2]. While dominant industries are striving for higher computational speed, quantum computing machines can perform tasks beyond the capabilities of classical methods implemented in the current computers. AI opens a new era of harnessing massive volumes of data in wide ranges of our lives and activities, superpositions and entanglement of qubits in quantum computing leverage the power and efficiency to derive insights from such data.

Photons entanglement has been proven to be one of the best forms for quantum communication due to the high transmission rate, short latency and well-established infrastructures along with mature detections technologies. Reliable entangled-photon sources remain a subject of development in performance, size and integration to unleash the power of entanglement in quantum computing.

Spontaneous parametric down conversion (SPDC) is one of the most passive optical processes implemented in correlated photons generation [3]. In general, the SPDC process occurs in birefringent crystals that have a large second-order nonlinearity, χ⁽²⁾. In SPDC, a pump photon at high frequency ωₚ travelling in a non-linear medium is converted into two correlated lower energy signal and idler photons, ωₛ and ωᵢ, called photon pairs, where the energy, defined by the frequency, and momentum, \vec{K}, are conserved. Energy conservation is expressed by

$${ω}_{p} = {ω}_{s} + {ω}_{i} \qquad EQ . 1$$

Momentum conservation that is also called phase matching gives

$${\vec{K}}_{p} = {\vec{K}}_{s} + {\vec{K}}_{i} \qquad EQ . 2$$

where

$$\vert {\vec{K}}_{p} \vert = \frac{2 π}{λ}$$

and λ is the wavelength.

Consequently, the speeds of the pump, signal and idler photons involved in SPDC process are equal. When three photons all travel in the same direction, the phase matching is colinear. Given the dispersion of nonlinear optical media, optical birefringence is deployed to equalize the photons' speeds and achieve phase matching, where birefringence refers to the dependence of the refractive index of anisotropic material on the polarization direction. Consequently, phase matching is polarization dependent and hence Type-0, Type-1 and Type-2 phase matching. Type-0 SPDC is defined by parallel polarization of the pump photon, signal and idler photons while the polarization of the pump photon in Type-1 process is orthogonal to that of both the signal and idler photons. In Type-2 SPDC, the polarization of the pump photon is orthogonal to the polarization of either the signal or idler while parallel to the other.

Photon or light polarization defines the direction of the electric component of the electromagnetic wave. Introducing the photons reference frame, the photon polarization state |ψ>, described by the projections of the electric field (α and β) onto the vertical and horizontal basis states |H [symbol] and |V [symbol] , respectively, is given as

$$\vert ψ 〉 = {e}^{i θ} ( α \vert H 〉 + {e}^{i ϕ} β \vert V 〉 ) \qquad EQ . 3$$

where are φ is the relative phase angle and θ is the global phase angle.

In colinear crystals and despite of the strong dispersion, phase matching is achieved through material engineering using quasi-phase matching (QPM) technique. The concept of the QPM is based on the periodic reversal of the local electric field in ferroelectric nonlinear crystals to enhance the flow probability of the pump wave energy into the daughter waves while interacting with considerably longer path in the crystal. Periodically poled crystals are thus produced as bulk crystals or with channel waveguide ensuring the optical confinement.

Many approaches for producing polarization-entangled photon pairs through SPDC process have been proposed over the past two decades [4,5,6,7,8]. In the case of colinear SPDC crystals, polarization entanglement can be obtained based on three main configurations using; (a) type-2 phase matching in a single crystal [4] or double-pass pump in a single type-0 crystal [9], (b) two crossed type-0 or type-1 crystals (c) interferometric schemes, namely Mach-Zehnder [7,11,12,13,14], Franson [15] and the Sagnac interferometers [16,17]. The interferometric methods are dominant in many state-of-art quantum optics experiments and applications due to the advantages of using colinear periodically poled crystals with different phase matching types to achieve polarization entanglement. This was firstly conceptualized in 1994 by Kwiat and coworker [18] and followed by the experimental demonstrations cited above.

Amongst these schemes, the inherent phase stability of the Sagnac interferometer, attributed to the common interferometric path of pump photons and photon pairs, i.e., daughter photons, that are combined into a single spatial mode [19], enables the generation of high-quality polarization entanglement and furthermore allows photon pairs separation into different spatial modes with no post-selective detection [16]. However, Sagnac interferometric crystal-based sources require highly precise alignment, highly skilled labor and a well-controlled environment to maintain the susceptible optical alignment. Moreover, the presence of a single half-wave plate (HWP), placed in the interferometer [16], imbalances the optical paths of the counter propagating photons due to the dispersion difference between the pump and Singles wavelengths. So, the reliability of such sources is still a challenging goal for any manufacturer. The fiber integration into such interferometric sources was proposed [20,21,22,23,24] by implementing waveguide that is butt-coupled to fiber optics. The cost and availability of such waveguides at various wavelengths continue to increase the limitations of this approach.

Mach-Zehnder interferometer, shown in Fiorentino work [12,13], contains a single PPNC where the beam is split and combined using polarizing beam displacers (PBDs). The two interferometric arms are imbalanced because of dispersion difference between the pump laser and the photon pairs wavelengths, assuming the two displacers are made from the same material. This issue was addressed later by using two PPNCs [25], where more PBDs are added to the interferometer to balance and combine the interferometric arms. However, adding a second PPNC brings another constraint: Both PPNCs must have identical physical length and optical properties which is very challenging and comes with a cost penalty.

The use of PBDs to split the pump beam and recombine the generated photon pairs into a single spatial beam is found to be impractical. Satisfying the parallelism conditions of multiple in-line components surfaces becomes a serious problem, given the lateral displacement of long displacers. This impairs the optical alignment and heavily degrades the coincidences rate. Adding thick optical elements such as PBDs is therefore not the ideal solution.

### SUMMARY OF THE INVENTION

A single pentagonal block with a small footprint and low profile allows for a quick integration of all of the optical elements required to construct a stable Sagnac interferometer. An interchangeable periodically poled nonlinear crystal is accommodated to generate polarization entanglement with high fidelity for polarization entanglement swapping. This block establishes a robust platform to offer cost effective and high-quality polarization-entangled photon sources operating with high stability in severe ambient conditions. The spectral bandwidth of photon pairs may be controlled by swapping the PPNC while the entanglement form is activated in energy and/or polarization domains via a built-in optical component. This may lead to a versatile product line including stand-alone operation as well as integrable units complying with quantum routers, distributed quantum sensing and quantum telecommunication.

In one embodiment of this invention, a block with pentagonal shape is engineered to efficiently construct a Sagnac interferometer in a smallest possible space. Besides the size reduction, this block design may require the engagement of a minimum number of in-line optical parts; two thin HWPs and a single PPNC to build plug-and-play sources with a lowest insertion loss. This in turn can lead to material cost reduction, size shrinkage and better integration capabilities. This may also enhance the long-term stability and source efficiency by reducing power consumption. The overall reliability may be enhanced as fewer parts are used. At the same time, the geometrical characteristics of such a block may be deployed as inimitable references for performing precise optical alignment efficiently. The optical parts may be eventually bonded to produce an alignment-free and robust building block.

The Sagnac interferometer may be implemented for the following reasons. First, to replace the use of a pair PPNCs, mentioned earlier in the Mach-Zehnder configuration [25], with a single PPNC. As a result, the photon noise level along with quality degradation, attributed to the physical and optical variations between the two PPNCs, may be addressed. Second, to resolve the interferometric arms imbalance of the single-crystal Mach-Zehnder scheme abovementioned [12, 13]. Thus, short pump pulses can be applied and daughter photons are tracked without revealing harmful pulse overlap in time domain. In one example embodiment, two thin HWPs may be used to assure perfect optical balance between the two interferometric optical paths for both the pump and photon-pairs wavelengths. The optical axes of the two HWPs are at angles (e.g., 22.5°) with respect to the polarization states of pump photons. This allows for a better extinction ratio than that of having a single HWP at 45°. This will be associated with axially rotating the PPNC around its axis, which is parallel to the propagation directions of pump photons, at an angle (e.g., 45°). Eventually, the polarization state of the incident photons from either side is normal to the periodically poled local electric field. Third, to eliminate the need for an active phase-stabilization system [16] duo to the intrinsic phase-stability or the so-called self-compensation effect of a Sagnac interferometer. Forth, the module allows the PPNC to be interchangeable. Type-0 or Type-1 SPDC crystals can be placed to generate polarization entanglement while it can be swapped with a Type-2 crystal for to achieve hyper-entanglement in polarization and frequency simultaneously. The crystal material and the type of the phase matching conditions determine the spectral bandwidth of photon pairs' emission. For instance, Type-2 SPDC in periodically poled lithium niobate (PPLN) and periodically poled potassium titanyl phosphate (PPKTP) generates photon pairs at 1550 nm and 810 nm, respectively, with a relatively narrow bandwidth [17,26]. Broader bandwidths and higher conversion efficiencies are obtained by using type-0 SPDC [17,27]. Fifth, the possibility of controlling the entanglement in polarization and energy domains can be deterministically controlled. Correlated photons and polarization-entangled photons can be generated through manipulating the polarization state of the pump laser via a built-in birefringence crystal or HWP.

The nature of this interferometric configuration may involve relatively high power routed back to the pump diode. This amount of back-reflected power can damage the spectral behavior and shorten the diode lifetime. Therefore, in one example embodiment an isolator may be embedded to allow for a module with a built-in laser diode. The generic module may also contain a diachronic filter (DF) plate, noise pump-removal filters, PBS and coupling optical lenses that are all incorporated into the pentagonal block. In addition, the compact housing may function as a compact heatsink for the pump diode. Moreover, it may be placed on a small thermoelectric cooler (TEC) for thermally stabilizing the PPNC.

In one example embodiment, there is provided a generic module comprising an interferometric Sagnac loop and PPNC accommodated in a single, compact pentagonal housing block.

In a further aspect of the generic module, said the interferometric Sagnac loop comprises: a PBS, two reflective mirrors, two HWPs and at least one noise-suppression filter integrated in the compact pentagonal housing block.

In yet a further aspect of the generic module, there is a pump; and a long-pass or short-pass dichroic filter at an angle of incidence of about 45° that is configured to direct a beam from the pump to the PBS and to direct photon pairs from the PBS to one output port.

In yet a further aspect, there is provided the generic module further comprising a dichroic filter, wherein said PBS routes photons transmitted through the dichroic filter into the interferometric Sagnac loop and directs photons pairs from the interferometric Sagnac loop to output ports.

In yet a further aspect, there is provided the generic module wherein said the pentagonal housing block provides two output ports, wherein one output port is routed to the PBS directly and the other output port receives photons transmitted from the dichroic filter and passed through the at least one noise-suppression filter.

In yet a further aspect, there is provided the generic module wherein said two output ports are coupled to fiber optics or provided with lenses for free-space applications.

In yet a further aspect, there is provided the generic module wherein an axial surface of the PPNC is perpendicular to a periodic poled local electric field, and the axial surface is oriented at 450 with respect to the s- and p-polarization states, as defined by the PBS.

In yet a further aspect, there is provided the generic module wherein said two HWPs are separated by the PPNC.

In yet a further aspect, there is provided the generic module wherein said two HWPs are configured to rotate the polarization states of pump photons and Singles with a high extinction ratio and to match an orientation of the PPNC as well as s- and p-polarization states of the PBS.

In yet a further aspect, there is provided the generic module wherein said two HWPs are configured to balance the Sagnac loop in both directions and erase information about a direction in which a conversion occurred, wherein a source operates in the pulsed mode while resolving very short pulses.

In yet a further aspect, there is provided the generic module wherein said pentagonal housing block further includes a built-in photodiode configured to monitor a pump power entering the Sagnac loop.

In yet a further aspect, there is provided the generic module wherein said pentagonal housing block further includes a built-in continuous or pulsed pump laser diode or an input port for an external pump laser source that is continuous or pulsed and is coupled in free-space or via an optical fiber.

In yet a further aspect, there is provided the generic module wherein the PPNC may be placed in the middle of the Sagnac loop.

In yet a further aspect, there is provided the generic module wherein the PPNC is one of a type-0, type-1 or type-2, configured for generating frequency entanglement, polarization entanglement and hyperentanglement via SPDC or any other nonlinear conversion process.

In yet a further aspect, there is provided the generic module further comprising more than one PPNCs of similar or different types.

In yet a further aspect, there is provided the generic module wherein said pentagonal housing block is mounted on a TEC.

In yet a further aspect, there is provided the generic module further comprising an optical polarizer at an input port, wherein the optical polarizer is configured to increase a polarization extinction ratio of a pump laser.

In yet a further aspect, there is provided the generic module further comprising an optical isolator at an input port, wherein the optical polarizer is configured to suppress back-reflected photons from a pump laser source.

In yet a further aspect, there is provided the generic module further comprising an optical attenuator at an input port, wherein the optical attenuator is configured to control a pump laser power and suppress back-reflected photons affecting a pump laser source.

In yet a further aspect, there is provided the generic module further comprising an optical polarization-state rotator of pump photons that is a HWP or electro-optical birefringent crystal configured to control an entanglement type and/or photon pairs number delivered to one or more output ports.

In yet a further aspect, there is provided the generic module wherein said polarization-state rotator is placed prior to or after a dichroic filter to control linear polarization state of a pump beam.

In yet a further aspect, there is provided the generic module wherein said the polarization-state rotator of pump photons is oriented so that powers of s- and p-polarized beams exiting the PBS, coupled to the interferometric Sagnac loop and delivered to either side of the PPNC, are balanced.

In yet a further aspect, there is provided the generic module wherein said the noise-suppression filters are installed at each output port to isolate any noise source affecting purity of photon pairs.

In yet a further aspect, there is provided the generic module wherein said set of noise-suppression filters are single or multiple noise-suppression filters configured to eliminate any wavelength component other than correlated or entangled photon pairs wavelengths with a high suppression ratio.

In yet a further aspect, there is provided the generic module wherein said pentagonal housing block is placed on a TEC to thermally stabilize a pump diode while the pentagonal housing block is used as a mechanical substrate to hold the PPNC and to tune phase matching wavelength via a single TEC.

In yet a further aspect, there is provided the generic module, wherein said PPNC is replaced by a periodically poled nonlinear waveguide (PPNW) that is optionally equipped with two input and output lenses.

### BRIEF DESCRIPTION OF THE DRAWINGS

The invention will be further understood from the following description with reference to the attached drawings illustrating example embodiments.

FIG. 1 illustrates a schematic representation showing the interferometric engine with a built-in pump laser diode and a type-0 (or type-1) PPNC.

FIG. 2 illustrates the polarization state of the pump photons in xy-plane is defined by δ while the beam enters the PBS in the negative z direction.

FIG. 3 illustrates a drawing of a PPNC geometry in Cartesian coordinates showing the orientation of the local electric field, which is periodically flipped in the +x direction, with respect to the HWPs and polarization state of the pump photons.

FIG. 4 illustrates a schematic representation of the interferometric engine that accommodates a Type-0 (or type-1) PPNC in clouding an additional optical port for coupling an external laser module.

FIG. 5 illustrates a schematic representation of the interferometric engine with a built-in pump laser diode and a type-2 PPNC.

FIG. 6 illustrates a schematic representation of the interferometric engine that accommodates a Type-2 PPNC with an optical port for coupling an external laser module.

FIG. 7 illustrates a schematic representation showing the interferometric engine with a built-in pump laser diode and a type-0 (or type-1) PPNC, with reference to size compared to a human hand.

### DETAILED DESCRIPTION

An exemplary embodiment of the disclosed invention will be set forth in detail with reference to the drawings, in which like reference numerals refer to like elements or method steps throughout.

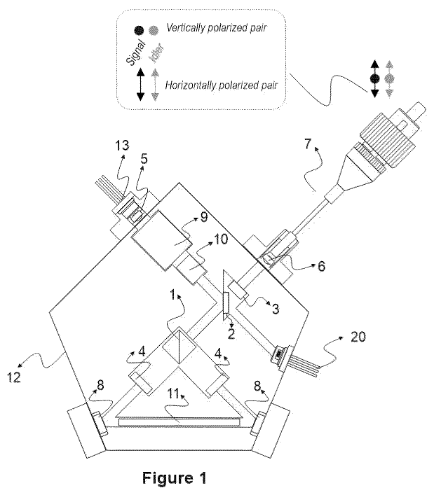

FIG. 1 shows an example embodiment of the present invention in a schematic representation showing the pentagonal engine block 12 accommodating type-0 (or type-1) PPNC 11. The first side allows the pump laser diode 13 installation. The beam profile of the pump laser diode may be controlled through the subsequent lens 5 and passes a Faraday isolator 9 and polarization rotator crystal 10. The beam with a controlled polarization state may be then directed to the PBS 1 through a long-pass dichroic filter (DF) 2 at 45° angle of incidence. The photodiode 20 receives the residual power leaking through WDM and the photocurrent can be calibrated to indicate the power received by the PBS 1. The PBS 1 establishes the Sagnac loop with the two pump inputs (toward the two identical HWPs 4) and a single output directing photon pairs to the main output port 7, located on the fifth side of the pentagon, after passing the DF 2, pump-removal filter set 3 and the coupling lens 6. The Sagnac loop is closed at the PPNC 11 by folding the optical paths using two mirrors 8, where the interferometric optical path constitutes an isosceles triangle. The two identical HWPs 4 may be optimized for the wavelength of pump and Singles wavelengths. The integration of a polarization state rotator 10, placed prior to the long-pass DF, which can be a rotatable HWP or electro-optical birefringent crystal 10, may be used to precisely control δ. Tuning δ, the clockwise and counter-clockwise propagating pump photons, delivered to the PPNC 11 through s-polarized and p-polarized components exiting the PBS 1, can be evenly directed to the PPNC 11 after correcting their polarization states via the HWPs 4.

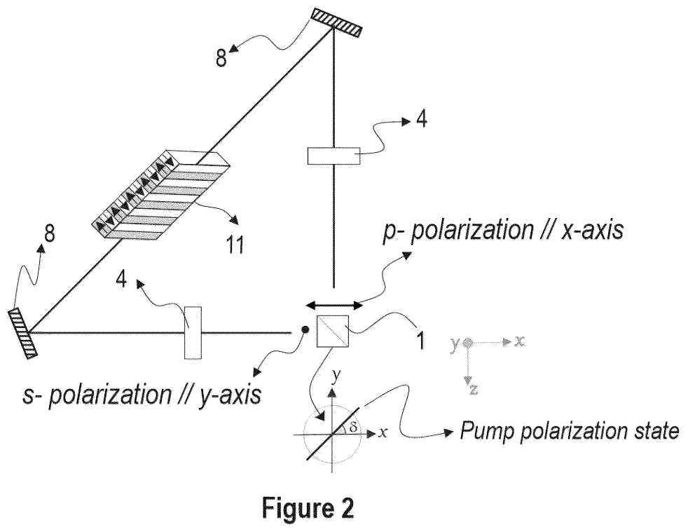

FIG. 2 shows an example embodiment of the present invention in a schematic illustration of the polarization state of the pump photons in xy-plane of the Cartesian coordinate representation, defined by δ, while the beam enters the BPS 1 in the negative z propagation direction is split into p-polarization component along x-axis and s-polarization component along y-axis. These photons may be then directed to two HWP 4, whose optical axes are, for example, at 22.5° in xy- and yz-planes, respectively. The HWPs may be placed in the equal sides of the isosceles triangle representing the Sagnac loop, where the two mirrors 8 are for closing the loop and forming the triangle optical path. The PPNC 11 may be located in the third side and rotated around its axis along the propagation direction at an angle (e.g., 45°) as seen from the PBS through the p-polarization component.

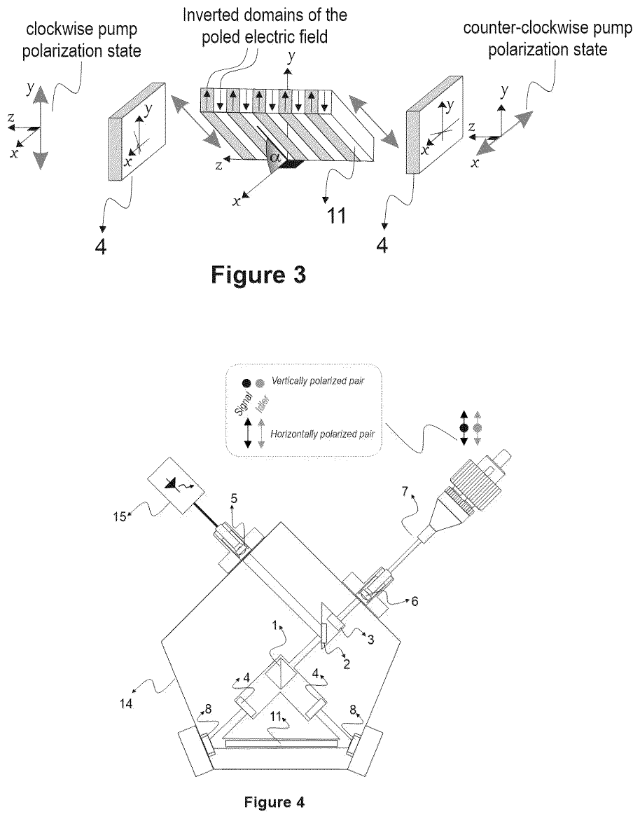

FIG. 3 shows an example embodiment of the present invention in a diagram showing the PPNC 11 (or 16) geometry and orientation in Cartesian coordinate axes and demonstrating the crystal local electric field that may be periodically flipped in the ±y directions. The polarization states of the pump photons bi-directionally propagating in ±2-directions and entering the PPNC 11 (or 16) from either side are represented by a, where α=45° in this exemplary embodiment. Clockwise and counter-clockwise propagating pump photons preferably share that same polarization state defined by α after passing their perspective HWP 4.

FIG. 4 shows an example embodiment of the present invention in a schematic representation showing the pentagonal engine block 14 accepting an external isolated pump laser and accommodating type-0 (or type-1) PPNC 11. The first side allows the external pump port installation. The beam profile of the external pump laser may be controlled through the subsequent lens 5. The beam, whose polarization state can be externally controlled, is then directed to the PBS 1 via a long-pass DF 2 at 45° angle of incidence. The PBS 1 establishes the Sagnac loop with the two pump inputs (toward the two identical HWPs 4) and a single output directing photon pairs to the main output port 7, located on the fifth side of the pentagon, through the DF 2, pump-removal filter set 3 and the coupling lens 6. The Sagnac loop may be closed at the PPNC 11 by folding the optical paths using two mirrors 8, where the interferometric optical path constitutes an isosceles triangle. The two identical HWPs 4 may be optimized for the wavelength of pump and Singles wavelengths. The integration of a polarization state rotator 9, placed prior to the long-pass DF 2, can be also considered in this case if needed.

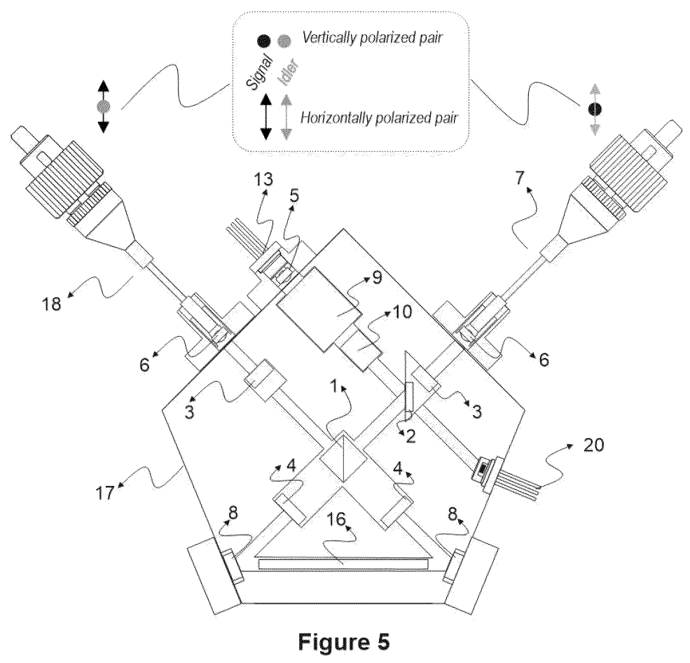

FIG. 5 shows an example embodiment of the present invention in a schematic representation showing the pentagonal engine block 17 accommodating type-2 PPNC 16. The first side allows the pump laser diode 13 installation. The beam profile of the pump laser diode may be controlled through the subsequent lens 5 and passes a Faraday isolator 9 and polarization rotator crystal 10. The beam with a controlled polarization state may be then directed to the PBS 1 via a long-pass DF 2 at 45° angle of incidence. The photodiode 20 receives the residual power leaking through WDM and the photocurrent can be calibrated to indicate the power received by the PBS 1. The PBS 1 may establish the Sagnac loop with the two pump inputs (toward the two identical HWPs 4) and two outputs directing photon pairs to the main output port 7, located on the fifth side of the pentagon, through the DF 2 while the other output port 18 may be installed on the first side next to the pump laser 13. The Singles of both output ports may be purified via pump-removal filter sets 3 and coupled to the fibers through lenses 6. The Sagnac loop may be closed at the PPNC 16 by folding the optical paths using two mirrors 8, where the interferometric optical path constitutes an isosceles triangle. The two identical HWPs may be optimized for pump and Singles wavelengths. The integration of a polarization-state rotator 10, placed prior to the long-pass dichroic filter DF 2, which can be a rotatable HWP or electro-optical birefringent crystal 10 that may be used to precisely control δ. This may allow achieving the balance state of the clockwise and counterclockwise propagating pump photons, delivered to the PPNC 16 through s-polarized and p-polarized components exiting the PBS1, and evenly directed to the PPNC 16 after the polarization state correction, performed via the HWPs 4.

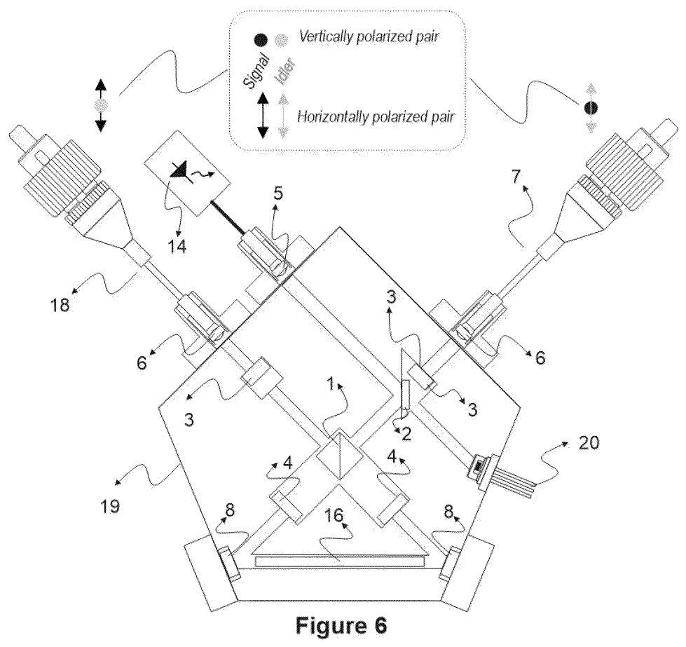

FIG. 6 shows an example embodiment of the present invention in a schematic representation showing the pentagonal engine block 19 accommodating type-2 PPNC 16 accepting an external isolated pump laser. The first side may allow the external pump laser input 14 installation. The beam profile of the pump laser diode may be controlled through the subsequent lens 5. The beam, whose polarization state can be externally controlled, may be then directed to the PBS 1 via a long-pass dichroic filter DF 2 at 45° angle of incidence. The photodiode 20 receives the residual power leaking through WDM and the photocurrent can be calibrated to indicate the power received by the PBS 1. The PBS 1 may establish the Sagnac loop with the two pump inputs facing the two identical HWPs 4 and two outputs directing the photon pairs to the main output port 7, located on the fifth side of the pentagon, through the DF 2 while the other output port 18 may be installed on the first side next to the pump laser 13. The Singles of both output ports may be purified or filtered out through a pump-removal filter set 3 and coupled to the fibers through lens 6. The Sagnac loop may be closed at the PPNC 16 by folding the optical paths using two mirrors 8, where the interferometric optical path constitutes an isosceles triangle. The two identical HWPs may be optimized for pump and Singles wavelengths. The integration of a polarization state rotator 10, placed prior to the long-pass dichroic filter DF 2, which can be a rotatable HWP or electro-optical birefringent crystal 10 that may be used to precisely control δ. This may allow balancing the clockwise and counterclockwise propagating pump photons, delivered to the PPNC 16 through s-polarized and p-polarized components exiting the PBS1, and evenly directed to the PPNC 16 after the polarization state correction, performed via the HWPs 4. An isolator 9, integrated prior to the long-pass dichroic filter DF 2, can be also considered in this case if needed.

An ideal entangled photon source may have excellent fidelity, highly stable performance and optional spectral specifications. In order to extend the lifetime of a source while maintaining photon generation stability, a mechanism ensuring high optical-coupling efficiency for collecting and delivering photons may be required. Lightweight and compact physical size may be complementary qualifications that may be desired for the case of integration.

As can be seen from the figures, the geometry of this module is uniquely deployed to use the simplest configuration with a minimum number of in-line optical components. This also provides highly stable performance, high-coupling efficiency, outstanding photon delivery and thus, remarkable fidelity. The first side of the pentagonal block may be used to install the pump laser diode or the input port as shown in FIG. 1. That may be followed by a Faraday isolator assembly and electro-crystal polarization state rotator. Also, the first side, shown in FIG. 5, hosts the second output port delivering the photon pairs, generated in the case of hosting a Type-2 PPNC. The resultant photon pairs are associated with two orthogonal polarization components and routed deterministically via the polarizing beam splitter (PBS). They get purified when passing through pump-removal filter/s right before the lens located at output port. The second side of the pentagon is used to install one of two mirrors that are required to close the triangular Sagnac loop. The third side is devoted to hosting the desired PPNC. The fourth side contains the opening window to accommodate the second mirror. The fifth side, which the other set of pump-removal filters faces, may be deployed to install the main output port delivering the photon pairs. The central area of the pentagon may contain the PBS that is followed by two identical half-wave plates (HWPs), placed at each side of the PPNC. The PBS may follow a DF facing the pump laser. The PBS has two functions. First, it delivers the counter-propagating pump photons to the PPNC. Second, it collects the counter-propagating Singles, generated within the PPNC, from both sides and deterministically direct them to the output port/s after passing the pump-removal filter/s.

One aspect of the present invention involves a generic module that has a pentagonal shape. The pump laser, pump isolation, output entanglement state controller and noise-suppression filters may all be physically integrated into it. This compact generic module represents a robust block unit for producing compact, alignment-free, all-inclusive and highly stable entangled photon sources. The photon pairs may be generated by means of an interchangeable single PPNC. Thus, the spectral bandwidth and production rate of the Singles can be tailored through the selection of the hosted PPNC. Combined with the inherent phase stability of the Sagnac interferometer scheme, the use of a single PPNC does not allow only for high quality entanglement but also for cost reduction and flexibility of targeting the desired pairs' spectral specifications. This may also eliminate the aforementioned impractical constraints that are associated with using two separate PPNCs or multiple PBDs in the Mach-Zehnder interferometer. The optical paths of the two interferometric directions may be precisely balanced and self-locked by implementing identical optical components, experienced in each direction. The fiber-coupled PPNC waveguides impose high cost and prohibitively limited by the fiber dispersion and mode singularity for specific wavelengths [28]. The implementation of a single PPNC in such a generic module can be the cost effective alternative without compromising the entanglement quality nor the generation efficiency.

The module can also include a Faraday isolator for incorporating a pump laser diode within the module. This may serve the purpose of the invention of building entangled photon sources that are simple in structure, small, light in weight and rigid enough for integration purposes. Furthermore, the spectral requirements, entanglement type and photon generation-rate can be realized by hosting a suitable PPNC such as a PPLN or PPKTP along with the suitable pump laser diode.

Capitalizing on the inherent stability of the compensation-free Sagnac interferometer, one aspect of this invention may satisfy the needs of up-to-date quantum-based technologies, such as:
i—Refine the design of the generic module for manufacturing high end entangled photon sources at low cost. Ensures stable optical alignment that is resistant to strong vibrations and thermal fluctuations.
ii—Provide flexible operating conditions and simple mechanical installation layout to comply with any severe requirements for critical applications, such as satellite communication and space-flight operations.
iii—Offer it as stand-alone instruments or OEM fully integrable sub-systems.
iv—Improve the source reliability and lifetime by reducing power consumption via enhancing the coupling efficiency

### a) Broadband Polarization-Entangled Photon Source

In one aspect of this invention, there is presented a pentagonal generic module as a generic block to build a highly stable interferometric broadband polarization-entangled photon source using a single PPNC 11 that is placed in the Sagnac loop. This unique engine can accommodate a built-in pump laser diode as shown in FIG. 1 or accept an external pump laser source depicted in FIG. 4.

An important and cost-effective feature of the Sagnac interferometer may be the use of a single PPNC 11 (or 16) that is bi-directionally pumped for generating polarization entanglement in both directions. However, this exact configuration implies a penalty of routing the pump power back to the laser diode, which may be mitigated by incorporating a compact Faraday isolator 9 to protect the laser spectral stability and extend the laser diode lifetime. In this embodiment, the concept of integrating an electro-optical birefringent crystal 10 into the pump port to control the polarization state of the pump photons entering the PBS hence, the Singles generation may be presented for the first time. The pump photons are actually directed to the PBS 1 after getting reflected on the DF 2. Built-in filters to pass the photon pairs only may be incorporated at the output ports.

In FIG. 1, the pentagonal block 12 of the generic module accommodating type-0 (or type-1) PPNC 11. A laser diode 13, in 5.6-mm TO-can or similar, may be installed on the first side of the block. The beam profile of the pump laser diode may be shaped through the subsequent lens 5, passed through an optical isolator 9 and polarization rotator crystal 10. The beam with a controlled polarization state may be then directed to the PBS 1 through a long-pass dichroic filter DF 2 at 45° angle of incidence. The PBS 1 forms the Sagnac loop. This function starts when the linearly polarized beam is deterministically split by the PBS 1 based on δ into two beams with orthogonal polarization states; p-polarized and s-polarized components as shown in FIG. 2. These two polarization states represent the two input pump photons counter-propagating within the loop including the PPNC 11. The ratio of these two ports may be controlled via the polarization rotator 10 through the angle δ and this embedded feature may be very useful to set the polarization state with respect to a given coordinate frame and to balance the photon twins in order to maximize the coincidences rate and hence, the entailment quality. After routing the two input ports that are specially overlapped in two directions, differentiated by photon propagation direction clockwise and counterclockwise as shown in FIG. 2, the input photons of each arm may be subject to a rotation of 45° through the HWP 4 to correct the polarization state, shown in FIG. 3, in order to pump the PPNC correctly to initiate the SPDC process and generate the photon pairs. After passing the PPNC 11, shown in FIG. 1, the second HWP 4 rotates the polarization state of pump photons and generated pairs another 45° to be received as p-polarization for clockwise direction while they will be received along the s-polarized state for counterclockwise propagating photons. Afterwards, the pump photons may be recombined again via the PBS 1 and routed back to the isolator and get out of the picture. The PBS 1 also may recombine the photon pairs counter-propagating throughout the loop into the same spatial beam that may be directed back to the long-pass dichroic filter 2 as shown in FIG. 1. Filter 2 passes the photon pairs into the output port after blocking the residual pump photons through the noise-suppression filter set 3. The pairs afterwards are coupled to a single-mode (or multi-mode) fiber 7 via the lens 6 with a complete (or a minimum degree of) indistinguishability between the photon pairs, whose orthogonal polarization states are |Hₛ [symbol] |Hᵢ [symbol] and |Vₛ [symbol] |Vᵢ [symbol] . Recalling EQ. 3 and assuming

$$a = β = \frac{1}{\sqrt{2}} ,$$

the polarization entanglement of an output photon pair is expressed as

$${{\frac{1}{\sqrt{2}} ( \vert H 〉 + {e}^{i φ} \vert V 〉 )}_{p u m p} \to \frac{1}{\sqrt{2}} ( \vert {H}_{s} 〉 \vert {H}_{i} 〉 + {e}^{i φ} \vert {V}_{s} 〉 \vert {V}_{i} 〉 )}_{output 1} \qquad EQ . 4$$

It is worth mentioning two aspects of the invention presented. First, the use of the pentagonal shape may help to reduce the number of optics as only two mirrors 8 fold the optical path and close the loop, where the PPNC 11 may be located between the two mirrors. This may result in a two-fold desired improvement: shorten the optical path and hence reduce the size and enhance the stability. Second, two similar HWPs 4 may be used to balance the interferometric optical paths of both pump photons and photon pairs. This may eliminate the phase discrepancy at the output port. In other words, the two HWPs may be identical as they are cut from a single HWP. The phase delays caused by material dispersion and experienced by the counter-propagating photons may be canceled out. Thus, no temporal walk-off or entanglement decoherence is experienced, the information about the direction in which the conversion occurred is erased [29] so that short pulsed-pump laser source can be used and the Singles can be resolved precisely. This may be achieved while fitting their functions of correcting the polarization states perfectly in the design. In fact, the use of a single dual-band HWP, as previously reported in other work, to rotate 90° does not only bring the problem of dispersion above mentioned but also degrades the extinction ratio of exiting polarized light especially at short wavelengths.

The photons conversion may be passively achieved through SPDC taking place in the PPNC 11 and the generated photon pairs may be then recombined spatially into a single beam via the PBS 1 with two orthogonal polarization components.

In a further example, in the case of type-0 PPLN, the spectral bandwidth of the photon pairs is about 90 nm, centered at 1550 nm while the pump diode operates at 775 nm with a single-peak and narrow linewidth.

In another embodiment, the generic module 12 may be modified to be coupled to an external pump laser module 14 with in-line external isolator as shown in FIG. 4. The pump diode may be replaced with a widow accommodating the holder of the lens 5.

The generic module can be driven by a pulsed or continuous pump laser, whose beam may be delivered in free-space or via a PM fiber as demonstrated in FIG. 4. Linearly polarized light entering the PBS may be set at δ=45° as illustrated in FIG. 2.

The compact housing of the generic module 12 (or 14) can be mounted on a commercially available TEC, Peltier module, to thermally stabilize the pump diode, tune the phase matching condition of the PPNC 16 to maximize the SPDC efficiency and stabilize the overall optical coupling efficiency and hence, the entanglement quality and resultant quantum performance.

### B) Narrow-Band Polarization-Entangled Photon Source

The implantation of Type-2 PPNC in a Sagnac interferometer is discussed in the publications [16, 17,29]. The PPNC 11, used in the previous embodiment is replaced by a type-2 PPNC 16 as shown in FIG. 5. Consequently, the pentagonal block 12 may be slightly altered to be providing a second output port 18 for coupling the orthogonal polarized photon pairs, received from each interferometric direction, into a single-mode (or multi-mode) fiber 7 and 18 using the lenses 6 after passing the noise-suppression filter sets 3. This describes the generic module accommodating Type-2 PPNCs. In this embodiment, sketched in FIG. 5, the SPDC process may be initiated exactly as thoroughly demonstrated in the aforementioned embodiment plotted in FIG. 1 and pump photons are taken care of when routed back to the optical isolator 9. However, the photon pairs of each interferometric propagation direction are now with two orthogonal polarization states. Therefore, half of the photon pairs generated in each direction, whose polarization is normal to that of the pump photons, are not specially overlapped with pump photon optical path once exiting the PBS 1. These Singles may be separated from their twins, combined through the PBS 1 and directed to a new optical path that may be perpendicular to that of their twins and pump photons and hence, will be routed to port 18 where they get coupled to the fiber via lens 6 after getting filtered through the noise-suppression filter set 3. In this case, the angle δ controls the polarization entanglement (polarization states of the Singles) and theoretically reaches its highest at 45° while the Singles number at each output port should not be affected by changing δ. As shown in FIG. 5, the pairs may be coupled to the two output ports 7 and 18, which are represented by single-mode (or multi-mode) fibers with a complete (or a minimum degree of) indistinguishability between the photon pairs. The orthogonal polarization states of the pairs delivered the first output port 1 (fiber 7) and second output port 2 (fiber 18) at a given moment are |Hₛ [symbol] ₁+e^{iφ}|Vₛ [symbol] ₁ and |Vᵢ [symbol] ₂+e^{iφ}|Hᵢ [symbol] ₂, respectively.

Recalling EQ. 3 and

$$assuming = β = \frac{1}{\sqrt{2}} ,$$

the polarization entanglement of an output photon pair is expressed as

$${{{{{{\frac{1}{\sqrt{2}} ( \vert H 〉 + {e}^{i φ} \vert V 〉 )}_{pump} \to \frac{1}{\sqrt{2}} ( \vert {H}_{s , i} 〉}_{1} \vert {V}_{s , i} 〉}_{2} + {e}^{i φ} \vert {V}_{i , s} 〉}_{1} \vert {H}_{i , s} 〉}_{2} )}_{{output}_{1 \& 2}} \qquad EQ . 5$$

where the index “s, i” indicates the daughter photon frequency that can be either @s or w; at a given moment. The two HWPs may be cut from a single HWP and thus, the phase delays caused by material dispersion and experienced by the counter propagating pump, signal and idler photons in both directions, cancel out. The relative phase can be then controlled to have singlet or triplet output states at φ=π or 0, respectively.

In yet a further embodiment, assuming a PPNC 16 is designed where the substance, length, birefringence and phase matching condition are all considered so that the polarization state of photo pair is not correlated to the photon daughter wavelength (or frequency). In that case, the polarization-entangled state does not have correlation with either the frequency-entangled state or the spatial mode and thus the hyperentanglement in polarization and frequency is expected. In such a hyperentanglement source when δ=45° the Singles at each output port 7 and 18 arrive with no the temporal walk-off and with orthogonal polarization states while the signals and idlers (or the frequency state) are not associated (or pre-defined) with the polarization state of the Singles at an output port, where the information about the direction in which the conversion occurred is erased.

The compact block of the generic module 17 (or 19) can be mounted on a commercially available TEC to thermally stabilize the pump diode, fine tune the phase matching condition of the PPNC 16 to maximize the SPDC efficiency and to stabilize the overall optical coupling efficiency and hence, the entanglement quality and resultant quantum performance. In another embodiment, the generic module 19 may be modified to be coupled to an external pump laser module 15 with in-line external isolator as shown in FIG. 6. The pump diode may be replaced with a window accommodating the holder of the lens 5, coupled to a PM fiber, or it can be used under free space coupling conditions.

It should be noted that the PPNC in the previous embodiment can be PPLN based or PPKTP based for degenerate and non-degenerate down conversions, but this invention including the devices and method is not limited to that. Moreover, the PPNC involved in the example embodiments mentioned herein may be replaced with a periodically poled nonlinear waveguide (PPNW), formed in bulk PPNC, to generate higher rates of photon pairs. In such an example embodiment, the optical coupling may be realized by either adding an achromatic lens to each side of the PPNW or by focusing and balancing the beam of the pump laser to match the mode fielded diameter of the PPNW.

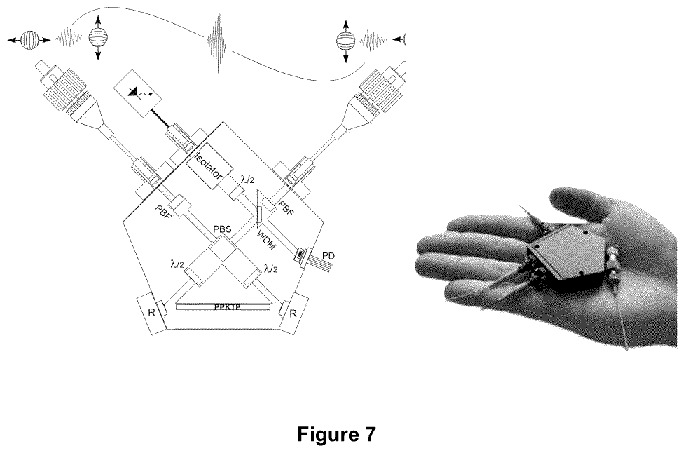

FIG. 7 illustrates a schematic representation showing the interferometric engine with a built-in pump laser diode and a type-0 (or type-1) PPNC, with reference to size compared to a human hand.

Following from the above description, it should be apparent to those of ordinary skill in the art that, while the methods and apparatuses herein described constitute exemplary embodiments of the present invention, the invention described herein is not limited to any precise embodiment and that changes may be made to such embodiments without departing from the scope of the invention as defined by the claims. Consequently, the scope of the claims should not be limited by the preferred embodiments set forth in the examples but should be given the broadest interpretation consistent with the description as a whole. Likewise, it is to be understood that it is not necessary to meet any or all of the identified advantages or objects of the invention disclosed herein in order to fall within the scope of any claims, since the invention is defined by the claims and since inherent and/or unforeseen advantages of the present invention may exist even though they may not have been explicitly discussed herein. The amounts, sizes and examples discussed herein are for example purposes only and should not limit the scope of the claims or variants thereof which would be understood by a person of skill in the art.

### REFERENCES

1. P. W. Shor, “Algorithms for quantum computation: discrete logarithms and factoring,” Proceedings 35th Annual Symposium on Foundations of Computer Science, 1994, pp. 124-134, doi: 10.1109/SFCS.1994.365700.
2. Feynman, R. P. Simulating physics with computers. Int J Theor Phys 21, 467-488 (1982).
3. D. C. Burnham, and D. L. Weinberg, “Observation of Simultaneity in Parametric Production of Optical Photon Pairs,” Phys. Rev. Lett. 25, 84-87 (1970).
4. P. G. Kwiat, K. Mattle, H. Weinfurter, A. Zeilinger, A. V. Sergienko, and Y. Shih, “New high-intensity source of polarization-entangled photon pairs,” Phys. Rev. Lett. 75, 4337-4341 (1995).
5. P. G. Kwiat, E. Waks, A. G. White, I. Appelbaum, and P. H. Eberhard, “Ultrabright source of polarization-entangled photons,” Phys. Rev. A 60, R773-R776 (1999).
6. Kim, Yoon-Ho & Chekhova, Maria & Kulik, Sergei & Rubin, Morton & Shih, Yanhua. (2001). Interferometric Bell-state preparation using femtosecond-pulse-pumped Spontaneous Parametric Down-Conversion. Physical Review A. 63. 10.1103/PhysRevA.63.062301.
7. M. Fiorentino, G. Messin, C. E. Kuklewicz, F. N. C. Wong, and J. H. Shapiro, “Generation of ultrabright tunable polarization entanglement without spatial, spectral, or temporal constraints,” Phys. Rev. A 69, 041801 (2004).
8. B.-S. Shi and A. Tomita, “Generation of a pulsed polarization entangled photon pair using a sagnac interferometer,” Phys. Rev. A 69, 013803 (2004).
9. Fabian Steinlechner, Sven Ramelow, Marc Jofre, Marta Gilaberte, Thomas Jennewein, Juan. P. Torres, Morgan W. Mitchell, and Valerio Pruneri, “Phase-stable source of polarization-entangled photons in a linear double-pass configuration,” Opt. Express 21, 11943-11951 (2013).
10. P. Trojek and H. Weinfurter, “Collinear source of polarization-entangled photon pairs at nondegenerate wavelengths,” Appl. Phys. Lett. 92, 211103 (2008).
11. P. Trojek, Ch. Schmid, M. Bourennane, H. Weinfurter, and Ch. Kurtsiefer, “Compact source of polarization-entangled photon pairs,” Opt. Express 12, 276-281 (2004).
12. M. Fiorentino and R. G. Beausoleil. Compact sources of polarization-entangled photons. Opt. Express, 16:20149, 2008.
13. Patent No.: U.S. Pat. No. 7,639,953 B2
14. P. G. Evans, R. S. Bennink, W. P. Grice, T. S. Humble, and J. Schaake, “Bright source of spectrally uncorrelated polarization-entangled photons with nearly single-mode emission,” Phys. Rev. Lett. 105, 253601 (2010).
15. Sanaka, K., Kawahara, K. & Kuga, T. New high-efciency source of photon pairs for engineering quantum entanglement. Phys. Rev. Lett. 86, 5620-5623 (2001).
16. T. Kim, M. Fiorentino, and F. N. C. Wong, “Phase-stable source of polarization-entangled photons using a polarization sagnac interferometer,” Phys. Rev. A 73, 012316 (2006).
17. Fabian Steinlechner, Marta Gilaberte, Marc Jofre, Thomas Scheidl, Juan P. Torres, Valerio Pruneri, and Rupert Ursin, “Efficient heralding of polarization-entangled photons from type-0 and type-II spontaneous parametric downconversion in periodically poled KTiOPO4,” J. Opt. Soc. Am. B 31, 2068-2076 (2014).
18. P. G. Kwiat, P. H. Eberhard, A. M. Steinberg, and R. Y. Chiao, “Proposal for a loophole-free Bell inequality experiment,” Phys. Rev. A 49, 3209-3220 (1994).
19. Michael Hentschel, Hannes Hubel, Andreas Poppe, and Anton Zeilinger. Three-color sagnac source of polarization-entangled photon pairs. Opt. Express, 17(25):23153-23159, December 2009.
20. P. Vergyris, F. Kaiser, E. Gouzien, G. Sauder, T. Lunghi, and S. Tanzilli. Fully guided-wave photon pair source for quantum applications. Quantum Science and Technology, 2(2):024007, June 2017.
21. Vergyris, Panagiotis, Florent Mazeas, Élie Gouzien, Laurent Labonte, Olivier Alibart, Sébastien Tanzilli and Florian Kaiser. “Fibre based hyperentanglement generation for dense wavelength division multiplexing.” Quantum Science and Technology (2019).
22. Florian Kaiser, Panagiotis Vergyris, Anthony Martin, Djeylan Aktas, Marc P. De Micheli, Olivier Alibart, and Sébastien Tanzilli, “Quantum optical frequency up-conversion for polarisation entangled qubits: towards interconnected quantum information devices,” Opt. Express 27, 25603-25610 (2019).
23. Costantino Agnesi, Marco Avesani, Andrea Stanco, Paolo Villoresi, and Giuseppe Vallone, “All-fiber self-compensating polarization encoder for quantum key distribution,” Opt. Lett. 44, 2398-2401 (2019).
24. GHz-Pulsed Source of Entangled Photons for Reconfigurable Quantum Networks Meritxell Cabrejo Ponce (Jena U., TPI and Fraunhofer Inst., Jena), André Luiz Marques Muniz (Fraunhofer Inst., Jena), Philippe Ancsin (Fraunhofer Inst., Jena), Christopher Spiess (Jena U., TPI and Fraunhofer Inst., Jena), Fabian Steinlechner (Fraunhofer Inst., Jena and Inst. Photonic Tech., Jena) Jan. 21, 2022.
25. R. Horn, Method and device for polarization entangled photon pair creation, 2021, Patent No.: U.S. Pat. No. 11,169,427 B2
26. Martin, A. Issautier, H. Herrmann, W. Sohler, D. B. Ostrowsky, O. Alibart, and S. Tanzilli, “A polarization entangled photon-pair source based on a type-II PPLN waveguide emitting at a telecom wavelength,” New Journal of Physics, vol. 12, p. 103005, 2010.
27. Han Chuen Lim, Akio Yoshizawa, Hidemi Tsuchida, and Kazuro Kikuchi, “Broadband source of telecom-band polarization-entangled photon-pairs for wavelength-multiplexed entanglement distribution,” Opt. Express 16, 16052-16057 (2008).
28. M. Wahbeh, Bright sources for pure photons entanglement, 2023, Patent No.: US20230384647A1
29. S. Grabher, I. Söllner, A. Predojević and G. Weihs, “Pulsed sagnac source of polarisation entangled photon pairs,” 2011 Conference on Lasers and Electro-Optics Europe and 12th European Quantum Electronics Conference (CLEO EUROPE/EQEC), 2011, pp. 1-1, doi: 10.1109/CLEOE.2011.5943405.

We claim:

1. A generic module comprising:
an interferometric Sagnac loop and periodically poled nonlinear crystal (PPNC) that is accommodated in a single, compact pentagonal housing block.

2. The generic module of claim 1, wherein said the interferometric Sagnac loop comprises:
a polarizing beam splitter (PBS), two reflective mirrors, two half-wave plates (HWPs) and at least one noise-suppression filter integrated in the compact pentagonal housing block.

3. The generic module of claim 2, further comprising:
a pump; and a long-pass or short-pass dichroic filter at an angle of incidence of about 45° that is configured to direct a beam from the pump to the PBS and to direct photon pairs from the PBS to one output port.

4. The generic module of claim 2, further comprising a dichroic filter, wherein said PBS routes photons transmitted through the dichroic filter into the interferometric Sagnac loop and directs photons pairs from the interferometric Sagnac loop to output ports.

5. The generic module of claim 4, wherein said the pentagonal housing block provides two output ports, wherein one output port is routed to the PBS directly and the other output port receives photons transmitted from the dichroic filter and passed through the at least one noise-suppression filter.

6. The generic module of claim 5, wherein said two output ports are coupled to fiber optics or provided with lenses for free-space applications.

7. The generic module of claim 1, wherein an axial surface of the periodically poled nonlinear crystals (PPNC) is perpendicular to a periodic poled local electric field, and the axial surface is oriented at 45° with respect to the s- and p-polarization states, as defined by the PBS.

8. The generic module of claim 2, wherein said two HWPs are separated by the periodically poled nonlinear crystals (PPNC).

9. The generic module of claim 2, wherein said two HWPs are configured to rotate the polarization states of pump photons and Singles with a high extinction ratio and to match an orientation of the periodically poled nonlinear crystals (PPNC) as well as s- and p-polarization states of the PBS.

10. The generic module of claim 2, wherein said two HWPs are configured to balance the Sagnac loop in both directions and erase information about a direction in which a conversion occurred, wherein a source operates in the pulsed mode while resolving very short pulses.

11. The generic module of claim 1, wherein said pentagonal housing block further includes a built-in photodiode configured to monitor a pump power entering the Sagnac loop.

12. The generic module of claim 1, wherein said pentagonal housing block further includes a built-in continuous or pulsed pump laser diode or an input port for an external pump laser source that is continuous or pulsed and is coupled in free-space or via an optical fiber.

13. The generic module of claim 1, wherein the periodically poled nonlinear crystals (PPNC) may be placed in the middle of the Sagnac loop.

14. The generic module of claim 1, wherein the periodically poled nonlinear crystals (PPNC) is one of a type-0, type-1 or type-2, configured for generating frequency entanglement, polarization entanglement and hyperentanglement via SPDC or any other nonlinear conversion process.

15. The generic module of claim 1, further comprising more than one periodically poled nonlinear crystals (PPNCs) of similar or different types.

16. The generic module of claim 1, wherein said pentagonal housing block is mounted on a TEC.

17. The generic module of claim 1, further comprising an optical polarizer at an input port, wherein the optical polarizer is configured to increase a polarization extinction ratio of a pump laser.

18. The generic module of claim 1, further comprising an optical isolator at an input port, wherein the optical polarizer is configured to suppress back-reflected photons from a pump laser source.

19. The generic module of claim 1, further comprising an optical attenuator at an input port, wherein the optical attenuator is configured to control a pump laser power and suppress back-reflected photons affecting a pump laser source.

20. The generic module of claim 2, further comprising an optical polarization-state rotator of pump photons that is a HWP or electro-optical birefringent crystal configured to control an entanglement type and/or photon pairs number delivered to one or more output ports.

21. The generic module of claim 20, wherein said polarization-state rotator is placed prior to or after a dichroic filter to control linear polarization state of a pump beam.

22. The generic module of claim 20, wherein said the polarization-state rotator of pump photons is oriented so that powers of s- and p-polarized beams exiting the PBS, coupled to the interferometric Sagnac loop and delivered to either side of the PPNC, are balanced.

23. The generic module of claim 2, wherein said the noise-suppression filters are installed at each output port to isolate any noise source affecting purity of photon pairs.

24. The generic module of claim 23, wherein said set of noise-suppression filters are single or multiple noise-suppression filters configured to eliminate any wavelength component other than correlated or entangled photon pairs wavelengths with a high suppression ratio.

25. The generic module of claim 2, wherein said pentagonal housing block is placed on a thermoelectric cooler (TEC) to thermally stabilize a pump diode while the pentagonal housing block is used as a mechanical substrate to hold the periodically poled nonlinear crystals (PPNC) and to tune phase matching wavelength via a single TEC.

26. The generic module of claim 1, wherein said PPNC is replaced by a periodically poled nonlinear waveguide (PPNW) that is optionally equipped with two input and output lenses.
